(19) United States
(12) Patent Application Publication
(10) Pub. No.: US 2023/0309538 A1
(43) Pub. Date: Oct. 5, 2023

(54) Lighted Insect Control Device

(71) Applicant: Alliance Sports Group, L.P., Roanoke, TX (US)

(72) Inventors: Todd Lee Marcucci, Mansfield, TX (US); Jimmy Prieto, Trophy Club, TX (US); Clark McCune, Roanoke, TX (US); James Brandon Roach, Keller, TX (US)

(21) Appl. No.: 18/128,342

(22) Filed: Mar. 30, 2023

Related U.S. Application Data
(60) Provisional application No. 63/325,824, filed on Mar. 31, 2022.

(51) Int. Cl. A01M 1/14; A01M 1/22

(52) U.S. Cl. CPC A01M 1/145; A01M 1/223; A01M 2200/012

(57) ABSTRACT

An insect control device is described having a housing with a base. A power source is disposed about the housing along with a first light source within the base. A second light source is in the base and is a single LED coupled to a controller. The controller is programmed to turn the single LED on at a randomized rate within a predetermined set of time segments and at a predetermined set of time increments.

### PRIORITY CLAIM

The present application claims priority to U.S. Ser. No. 63/325,824 filed on Mar. 31, 2022 entitled “Lighted Insect Control Device” which is incorporated herein by reference in its entirety.

### FIELD OF INVENTION

The present technology relates to lighting devices. Specifically, multiple use lighting devices and methods of operation and devices for insect extermination.

### BACKGROUND

Insect control devices are helpful in reducing unwanted disease carrying vectors, such as mosquitoes, gnats, and the like. Mimicking a natural light pattern is thought to increase insects to traps where they may be disposed of. Prior devices require a plurality of light sources to mimic the natural light pattern. This increases the costs associated with manufacturing, including the need for an increased footprint on circuit boards, multiple solder joints, and increased drivers. It is therefore desirable to have an insect control device that mimics natural light with the same efficiency and allure with fewer components.

### BRIEF DESCRIPTION OF THE DRAWINGS

To further clarify the above and other aspects of the present technology, a more particular description of the invention will be rendered by reference to specific aspects thereof which are illustrated in the appended drawings. It is appreciated that these drawings depict only typical aspects of the technology and are therefore not to be considered limiting of its scope. The drawings are not drawn to scale. The technology will be described and explained with additional specificity and detail through the use of the accompanying drawings in which:

FIG. 1 is an exploded view of a lighted insect control device in accordance with one aspect of the technology;

FIG. 2 is an exploded view of an upper assembly of a lighted insect control device in accordance with one aspect of the technology;

FIG. 3 is an exploded view of a portion of a lower assembly of a lighted insect control device in accordance with one aspect of the technology;

FIG. 4 is a side view of a lighted insect control device in accordance with one aspect of the technology; and

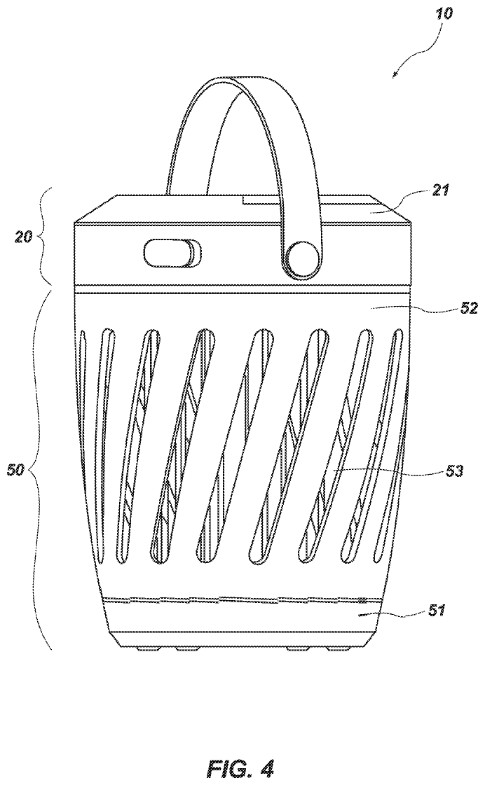

FIG. 5 is a cross section side view of a lighted insect control device in accordance with one aspect of the technology.

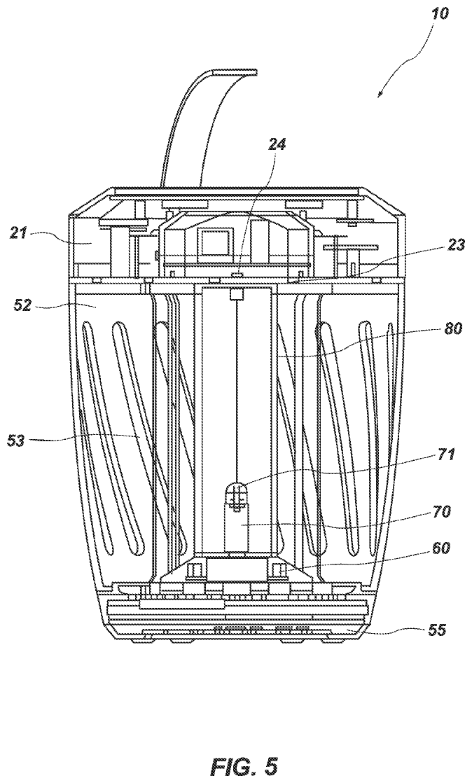

### DESCRIPTION OF EMBODIMENTS

Although the following detailed description contains many specifics for the purpose of illustration, a person of ordinary skill in the art will appreciate that many variations and alterations to the following details can be made and are considered to be included herein. Accordingly, the following embodiments are set forth without any loss of generality to, and without imposing limitations upon, any claims set forth. It is also to be understood that the terminology used herein is for the purpose of describing particular embodiments only, and is not intended to be limiting. It is also understood that aspects of one embodiment may be used in connection with other aspects. Unless defined otherwise, all technical and scientific terms used herein have the same meaning as commonly understood by one of ordinary skill in the art to which this disclosure belongs.

As used in this specification and the appended claims, the singular forms “a,” “an” and “the” include plural referents unless the context clearly dictates otherwise. Thus, for example, reference to “a layer” includes a plurality of such layers.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open-ended term, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. The term “coupled,” as used herein, is defined as directly or indirectly connected in an electrical or nonelectrical manner. Objects described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”. For example, for the sake of convenience and brevity, a numerical range of “about 50 angstroms to about 80 angstroms” should also be understood to provide support for the range of “50 angstroms to 80 angstroms.”

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

Reference in this specification may be made to devices, structures, systems, or methods that provide “improved” performance. It is to be understood that unless otherwise stated, such “improvement” is a measure of a benefit obtained based on a comparison to devices, structures, systems or methods in the prior art. Furthermore, it is to be understood that the degree of improved performance may vary between disclosed embodiments and that no equality or consistency in the amount, degree, or realization of improved performance is to be assumed as universally applicable.

The term “flashlight” or “lantern” as used herein is used as an example of a lighting device that may employ the technology herein but should not be construed as limiting what kinds of lighting devices may employ the current technology. As such, the term flashlight should be broadly construed to include hand held lighting devices, headlamps, and other various lighting devices.

An initial overview of the technology is provided below and specific technology embodiments are then described in further detail. This initial summary is intended to aid readers in understanding the technology more quickly, but is not intended to identify key or essential features of the technology, nor is it intended to limit the scope of the claimed subject matter.

Broadly speaking, aspects of the current technology improves insect control systems that attracts, traps, and/or kills insects that are attracted by light. Advantageously, in one aspect of the technology, a single LED is employed to vary light intensity related to ambiance while other LEDs in other portions of the device are used to attract insects through other means. The ambiance or natural look of a light source, such as a candle, is one way of attracting an insect. Another way may include light propagated at a specific wavelength. Using a single LED for ambiance or the appearance of “natural light” reduces the complexity of the device, reducing the need for multiple circuit drivers, solder joints, and valuable circuit board real estate. Advantageously, in an additional aspect of the technology, less light than is more visible to the human eye is emitted from the device than light that is detectable and attractive to insects. In this manner, the functionality and utility of the device for insect extermination is improved while other utilitarian aspects are preserved. The light from the different light sources may be varied in a number of ways including, but not limited to varied duty cycles, variable power input to any of the light sources, increased numbers of lights within any particular light source, random power input and/or duty cycles, variable light frequencies and the like. A combination of these methods is also contemplated herein. The traps used to exterminate the insects once they are attracted to the light can vary from application to application as suits the environment, available resources, or user preference, so long as the trap exterminates the insects at some point in time after they encounter the trap.

For example, in one aspect of the technology, a light source attracts insects to a trap comprising an electrical grid or other conductive surface, where they are electrocuted by touching two wires with a high voltage between them. In one aspect, the electrical grid, or other electrically conductive surface, is housed in a protective cage or plastic shroud, grounded metal bars, or some other material, to prevent people or animals from touching the high voltage grid or electrically conductive surface. In another aspect, the electric grid is located within a housing that is not susceptible to contact and thus does not require a protective cage. In one aspect, a first and second light source are disposed about the protective shroud and are designed to emit/propagate visible light and/or ultraviolet light. In one aspect, a high-voltage power supply powered by electricity, which may be a simple transformerless voltage multiplier circuit made with diodes and capacitors, generates a voltage high enough to conduct through the body of an insect which bridges two grids, but not high enough to spark across the air gap. Enough electric current flows through the small body of the insect to heat it to a high temperature and exterminate it. In one aspect, the voltage level ranges from about 500 to 600 volts.

In one aspect, the lighting sources and electrical grid operational options are all operable from a single control switch. In an additional aspect, first and second light sources are disposed about the protective shroud and are designed to emit ultraviolet light at one frequency that is visible to the human eye and another frequency that is not visible to the human eye. In one aspect of the technology, the plurality of lights in the first or second light sources comprise LED lights that are positioned within a housing and can be within or near the shroud or near the electrically conductive surface. In an aspect where additional light sources are used that emit or propagate visible light, said light sources may be located within the shroud, near the electrically conductive surface, or distally from the electrically conductive surface.

In one aspect, the housing comprises a power source (e.g., a rechargeable battery, non-rechargeable battery, a power cable to an outlet, etc.) and a control circuit capable of regulating the amount of power that is provided to the LED lights. The control module is coupled to external or internal switches that may be operated by a user to change the modes of operation of the different LED lights including, but without limitation, changing the amount of power to the first light source independent of the second light source, changing the amount of power to the second light source independent of the first light source, or simultaneously changing the amount of power to the first and second light source. In one aspect, the modes of operation indirectly change the power by changing the duty cycle of the LEDs. In another aspect, the power that is provided to the different light sources is increased or decreased by regulating the voltage or other component of electricity, sent to the light sources.

In still another aspect of the technology, the insects are not trapped/exterminated through electrocution. Rather, the insects are exterminated in other traps associated with the housing of the extermination device. In one aspect, the insects are attracted to the housing that includes an adhesive strip where the insects are adhered upon contact and are exterminated through dehydration. In another aspect, the insects are attracted to enter a one-way portal into a chamber that has no exit or that is otherwise difficult to exit. In this manner, the insects are trapped in the chamber and are also exterminated through dehydration. In another aspect, the insects are attracted to a chamber where they are exterminated by the blunt force of a moving blade as disclosed in U.S. Pat. No. 10,701,923, which is incorporated herein by reference in its entirety.

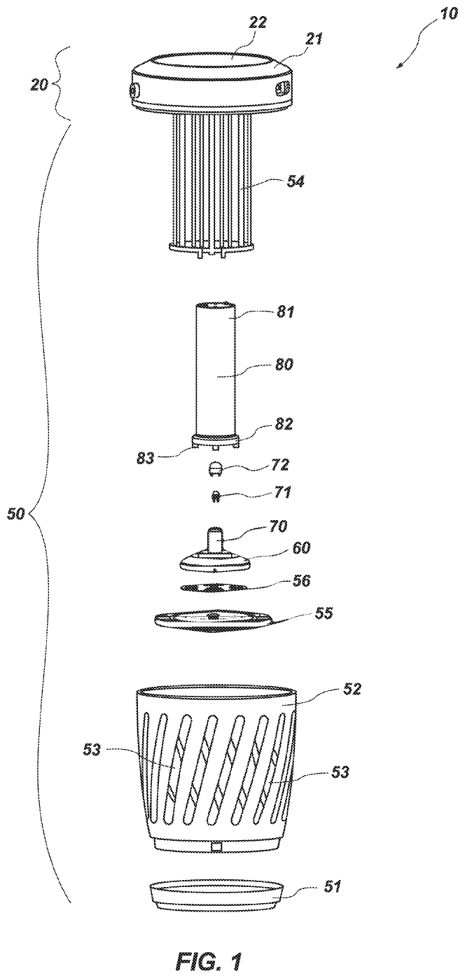

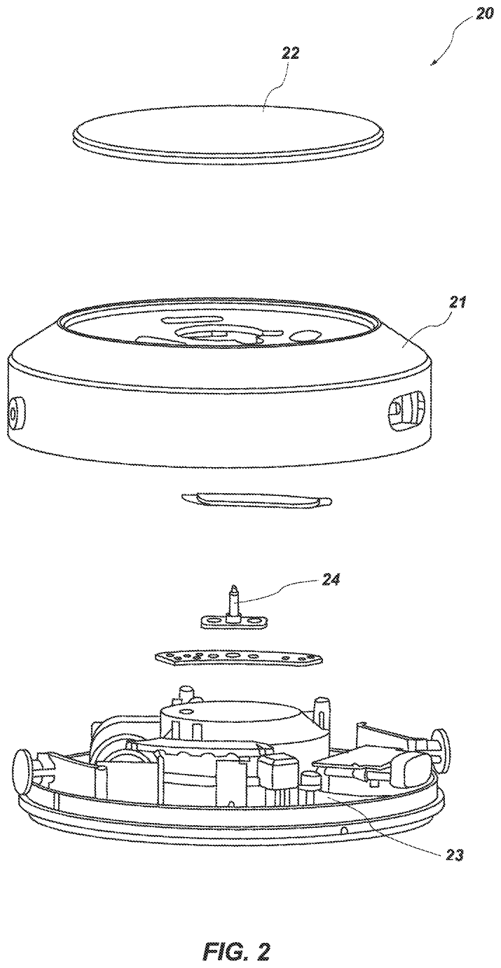

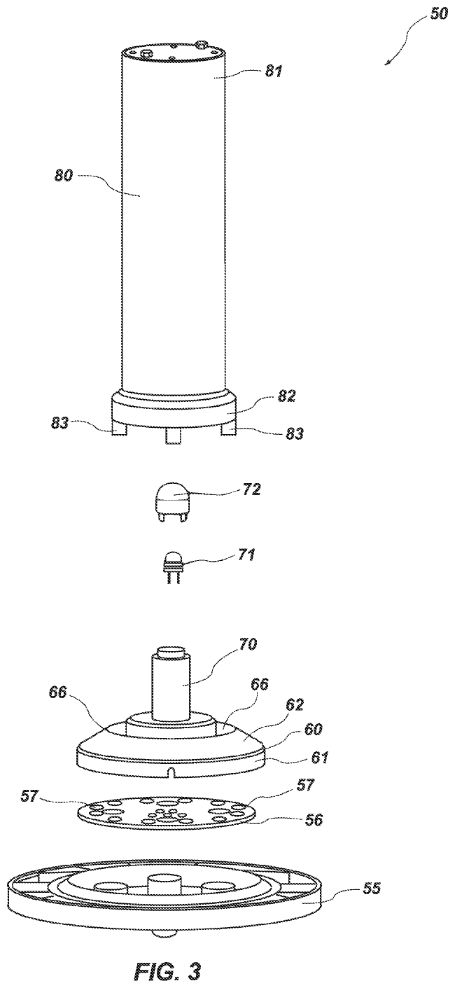

With reference to FIGS. 1-3, in one aspect of the technology, the lighted insect extermination device 10 comprises an upper assembly 20 and lower assembly 50. The upper assembly 20 houses the controls for the lighting and bug zapper grid 54. In one aspect, the upper assembly 20 comprises an upper cover 21 with integrated solar panel 22. While a solar panel 22 is referenced, the device may be solar powered, but may also have a combination of power sources including, RC, alkaline, and/or USB/AC-DC adapter power. In the situation where a solar panel 22 is used, the device 10 may use the current derived from the solar panel 22 to activate the device 10, depending on the mode setting. In one example, the upper cover 21 is used to activate a mode switch and/or may be activated by a hall effect sensor. In another aspect, the unit may be activated (though not constantly powered) by solar power 22. In another aspect, the device 10 may operate entirely on solar power. In one aspect of the technology, the controls for regulating the bug zapper grid 54 and different lighting components are mounted on a printed circuit board (PCB) 23 disposed within the upper cover 21. A switch 24 is mounted to the PCB 23 and coupled to a programmable logic controller (PLC) about the PCB 23. The PLC is configured to regulate the different lighting components and other power functions of the device 10.

In one aspect, the lower assembly 50 comprises a base 51 coupled to a protective shroud 52. The protective shroud 52 comprises a top circumference that is greater than a bottom circumference, tapering from the top to the bottom. The shroud 52 comprises linear slots 53 oriented at a slant or angle with respect to a longitudinal axis of the shroud 52. A bug zapping grid 54 is disposed within the shroud 52 and is coupled to a mounting plate 55. A PCB 56 is disposed atop the mounting plate 55. The lower PCB 56 comprises one or more LEDs 57 configured to propagate light at a frequency ranging from about 10 nm to 400 nm, 100 nm to 400 nm, 200 nm to 400 nm, and 300 nm to 400 nm. In another aspect, one or more LEDs are configured to propagate light at a frequency ranging from about 100 nm to 300 nm and 200 nm to 300 nm. These frequencies of light typically correspond with ultraviolet frequencies. In one aspect, the LEDs 57 are disposed about the top of the PCB 56 and disposed about the outer edge of the top of the PCB 56. In one aspect, some of the LEDs 57 are configured to propagate light at a first frequency range while the remainder of the LEDs 57 are configured to propagate light at a different frequency range. While reference is made herein to a PCB 56 and LEDs 57 or an LED 71, it is understood that the assembly for propagating light, in one aspect, comprises a chip-on-board or COB LED assembly. In one aspect, the single LED 71 comprises a single chip or discrete surface mounted LED.

In one aspect of the technology, the lens 72 is replaced with a light pipe or fiber optic configured to transmit and distribute light. The light pipe is rigid or flexible as suits a particular application. In one aspect, the light pipe is translucent, in that it permits a portion of light to be emitted from the sides of the pipe. In another aspect, however, the light pipe is opaque.

In one aspect of the technology, a lens 60 is disposed about the PCB 56 to diffuse light from the plurality of LEDs 57 or a single LED 71. The lens 60 may be transparent or translucent as suits a particular purpose. In one aspect of the technology, the lens 60 comprises a planar edge 61 parallel with a longitudinal axis of the lower assembly 50 and an inner sloping edge 62. A center mount 70 is disposed through and/or about the top of lens 60 and is configured to accommodate a single LED 71 therein. The single LED 71 is coupled to the PCB 56. In one aspect, the center mount 70 extends upward from the lens 60 and into an upper diffuser tube or upper diffuser shroud 80. In one aspect, a lens 72 is disposed atop the single LED 71. The diffuser shroud 80 comprises a cylindrical top 81 with a cylindrical bottom 82 comprising tabs 83 configured to mate with the top of lens 60. The cylindrical bottom 82 is also configured to mate with an annular groove 66 disposed in the top of lens 60 and is centered about the top of lens 60. In one aspect of the technology, the diffuser 80 is translucent. Meaning, it permits light to travel through, but the light is scattered or diffused.

In one aspect, the diffuser 80 has a circumference that is less than the circumference where the LEDs 57 disposed about PCB 56 are located. In this manner, the LEDs 57 that are located on PCB 56 may direct light upward outside of the diffuser 80. However, in another aspect, some or all of the LEDs 57 disposed about PCB 56 are located within the diffuser 80. In one aspect, LEDs 57 that propagate visible light are located within the diffuser 80 while LEDs 57 that propagate non-visible UV light are located outside of the diffuser 80. In one aspect, the lens 60 and the diffuser 80 have different degrees of translucence. In another aspect, the translucence of the lens 60 and diffuser 80 are the same.

In one aspect of the technology, the single LED 71 is the only light source propagating light from within the diffuser 80. The single LED 71 propagates light in the visible spectrum ranging from about 420 nm to about 700 nm. In one aspect, the duty cycle of the single LED 71 is adjusted according to a randomized pattern. In another aspect, intensity of the light propagated from the single LED 71 is varied in a randomized manner by adjusting the power level (e.g., voltage) sent to the single LED 71. In another aspect, the frequency of light propagated from the single LED 71 is adjusted in a randomized manner. In those instances, the PLC to which the LED 71 is coupled, controls the operational parameters of the single LED 71.

In one aspect of the technology, the duty-cycle or the intensity of the single LED 71 is determined by a random number generation process. In this manner, the particular outcome sequence may contain some patterns detectable in hindsight but unpredictable to foresight. Meaning they are not predetermined in any way, though they may be randomized within a predetermined set of parameters. In one aspect of the technology, an “on-off” sequence associated with the single LED 71 is associated with a random pattern within an assigned or predetermined time cycle. For example, in one aspect, the LED 71 will randomly turn on and off in different time segments ranging from 0.01 to 1 seconds, 0.1 to 1 seconds, 1 to 2 seconds, and the like. In each of these different time segments, the on-off cycle may be in increments of 0.01 seconds, 0.05 seconds, 0.1 seconds, 0.2 seconds, or 0.5 seconds, for example. Other time segments at other increments may be used as suits a particular purpose. This advantageously limits the time constraints so that the single LED 71 is not in an off cycle (or other event cycle) for too long to make the utility of the device ineffective.

In one aspect of the technology, the on-off cycle is regulated by a sub-routine or sub-cycle. Meaning, the single LED 71 will switch from an “off” to an “on” status during a randomized predetermined range time segments within a predetermined range of time increments. However, switching from an “on” to an “off” status is regulated by a separate logic. In one aspect, when the single LED 71 is switched to an “on” status, an intensity sub-routine is activated. In one aspect, the intensity subroutine will change or adjust the amount of power provided to the single LED 71, the frequency of light being propagated from the single LED 71, and/or the duty cycle associated with the single LED 71.

In one aspect, the intensity sub-routine also makes use of the randomization process built into the device. Meaning, the power level is adjusted within a predetermined power range and within a predetermined time cycle. However, the timing of the power level adjustments and the power level adjustments themselves are randomized within the predetermined range. Likewise, the frequency of light being propagated from the single LED 71, and/or the duty cycle associated with the single LED 71 are adjusted within predetermined ranges, both in terms of the time cycle and the parameter (i.e., duty cycle, frequency, etc.) being adjusted. Those adjustments are made within a predetermined range, but what the specific adjustment within that range is, is randomly assigned.

In one aspect, the processor comprises a hardware random-number generator (HRNG) built into the PLC. In one aspect, the HRNG comprises a transducer to convert some aspect of a physical phenomena to an electrical signal to increase the amplitude of the random fluctuations to a measurable level, and some type of analog-to-digital converter to convert the output into a digital number. By repeatedly sampling the randomly varying signal, a series of random numbers is obtained. Each generation is a function of the current value of a physical environment attribute of the device 10. In another aspect, however, random number generation is completed through the use of pseudorandom number generators (PRNG) that generate numbers that appear random but can be pre-determined in some instances—these generations can be reproduced by knowing the state of the PRNG. In one aspect, the PRNG comprises a linear congruential generator programmed into the PLC using the following recurrence:

Xₙ₊₁=(aX₁+b)mod m

where a, b and m are large integers, and Xₙ₊₁ is the next in X as a series of pseudorandom numbers. The maximum number of numbers the formula can produce is the modulus, m. Other algorithms may be employed, for example, including the Mersenne Twister algorithm. In one aspect, the duty-cycle, power level, and/or intensity of the single LED 71 is created through a PRNG. In one aspect, the PRNG sequence is bound within certain time increments and/or time segments.

In one aspect of the technology, the numbers generated from the HRNG or PRNG, or other process, correspond to a table of time segments and/or time increments. A simplified, non-limiting example, of such a table is noted below, though it is understood that many other combinations may be used:

| | Duration | | Time | | Time |
|---|---|---|---|---|---|
| 1^{st} | of Event | 2^{nd} | Increment | 3^{rd} | Segment |
| Number | (seconds) | Number | (seconds) | Number | (seconds) |
| 1 | 1 | 1 | 0.1 | 1 | 0.1-0.5 |
| 2 | 2 | 2 | 0.05 | 2 | 0.1-0.5 |
| 3 | 3 | 3 | 0.2 | 3 | 0.1-0.5 |
| 4 | 0.5 | 4 | 0.01 | 4 | 0.01-0.1 |
| 5 | 0.75 | 5 | 0.02 | 5 | 0.01-0.1 |
| 6 | 1 | 6 | 0.025 | 6 | 0.01-0.1 |
| 7 | 1.25 | 7 | 0.05 | 7 | 0.01-0.1 |
| 8 | 2 | 8 | 0.1 | 8 | 0.1-2 |
| 9 | 2.5 | 9 | 0.25 | 9 | 0.1-2 |
| 10 | 3 | 10 | 0.5 | 10 | 0.1-2 |

In this example, a plurality of random numbers between one and ten may be generated. If the first number was number 1, the PLC would activate the on-off cycle, power level adjustment, frequency adjustment, or duty-cycle adjustment for a period of time of one second. If the second number generated was number 5, then during the one second period of the “event duration”, the event (e.g., adjusted on-off-cycle, power level adjustment, frequency adjustment, or duty-cycle adjustment, etc.) would be adjusted in 0.02 seconds increments. If the third number generated was 3, the increments would be constrained between 0.1 and 0.5 seconds.

In one aspect of the technology, similar logic is applied in determining the adjustments to the power level, frequency, and/or duty-cycle. Meaning, not only is the time of the adjustments assigned through the random number process, but the degree to which power, frequency, or duty-cycle is adjusted. For example, in one aspect, another two columns are associated with the table with another random number correlating to different levels of voltage, for example, sent to the LED or LEDs. Likewise, the table may also be associated with different levels of duty-cycles, and/or different frequencies to be propagated from the LED or LEDs. In any event, the different numbers that are generated from the random or pseudorandom process correspond to different events that mimic a more natural occurring light.

In another aspect of the technology, the adjusted lighting parameters (i.e., on-off, duty-cycle, power, and/or frequency adjustments) are adjusted according to a predetermined pattern that repeats itself after a predetermined period of time. The pattern, however, appears random and is repeated after a predetermine period such that the user will not be able to discern that the pattern is repeating itself. For example, in one aspect of the technology, the duty-cycle is adjusted up and down in increments ranging from about 1% to about 3% about every 0.01 seconds. That adjustment occurs according to the preprogrammed pattern shown below in Table 1.

However, it is understood, that the adjusted lighting parameter may change at different intervals (+/−5%, 10%, etc.) at different increments (0.1 seconds, 0.25 seconds, etc.) and over different periods (10 seconds, 22 seconds, 3 minutes, etc.) so long as the average user giving the average attention one gives to such devices cannot discern the pattern.

In one aspect of the technology, a portable battery is used as the power source of the insect control device. The portable battery and/or the PLC is configured to detect the amount of voltage (or remaining power) remaining in the battery. The amount of power remaining in the battery (i.e., the charge level) is used as a first parameter to determine what types of adjustments are available for the insect control device. In one aspect, when the charge level is greater than 50%, all of the available combinations of “natural light” mimicking patterns are available to use. However, when the charge level is less than 50%, those light mimicking patterns that consume the greatest amount of power would be eliminated as possible combinations. Other charge levels may be used to refine available combinations at any level of desire granularity. For example, the number of combinations may be segmented into fourths and ordered from highest level of power consumption to the lowest level of power consumption. From 75% to 100% charge capacity, all four segments are available for use. From 50% to 75%, only the bottom three segments are available for use. From 25% to 50% charge level, only the bottom two segments are available and from 1% to 25%, only the lowest power consuming segment is available. In this manner, advantageously, the natural light mimicking function is maintained while power consumption is optimized. Moreover, the user may be able to detect when the power level or charge of the battery is low by knowing what light mimicking function is available. In another aspect of the technology, battery charge or battery level is made known to the user and optimized for the user by limiting the amplitude of light propagated by the LED. The amount of energy carried by a wave is related to the amplitude of the wave. A high energy wave is characterized by a high amplitude; a low energy wave is characterized by a low amplitude. In one aspect of the technology, when the battery charge is less than 50%, for example, the amplitude of light emanating from the LED is limited or modulated to less than 50% of its maximum, though other combinations of charge and amplitude limitations may be used as suits a particular application. In another aspect, the battery charge or battery level is made known to the user and optimized for the user by limiting the frequency of light propagated by the LED. The lower the battery charge left on the device, the lower the frequency of light will be propagated from the LED.

While the term LED is used herein in connection with a light source, it is understood that a single LED may be used as a first light source or a plurality of LEDs with similar capabilities may be used. Similar LEDs may be disposed on a similar chip or substrate or they may be disposed on different chips and different substrates and disposed about different locations of the housing as suits a particular design. Meaning, LEDs with similar characteristics may be located about numerous different locations of the device. Moreover, other light sources may be used besides LEDs as suits a particular application.

In one aspect of the technology, the light sources or LEDs are configured with pulse-width modulation (“PWM”) to “dim” the LED while still attracting insects that are attracted to certain frequencies of UV radiation or for other purposes. PWM is one way of regulating the brightness of a light. In one aspect, light emission from the LED is controlled by pulses wherein the width of these pulses is modulated to control the amount of light perceived by the end user. When the full direct current voltage runs through an LED, the maximum of light is emitted 100% of the time. That is, the LED emits light 100% of the time when in an “on” mode. With PWM, the voltage supplied to the LED can be “on” 50% of the time and “off” 50% of the time so that the LED gives off its maximum amount of light only 50% of the time. This is referred to as a 50% duty cycle. In this scenario, if the on-off cycle is modulated fast enough, human eyes will perceive only half the amount of light coming from the LED. That is, with such an input on the LED, the amount of light given off appears diminished by 50%. While specific reference is made to a 50% duty cycle, the LED duty cycle of the light sources described herein (UV and/or white LED, etc.) may be greater or lesser than 50% as suits a particular purpose. For example, the UV LED(s) and/or other LEDs propagating light at different wavelengths may have a duty cycle that ranges from 25% to 40%, 40% to 50%, 50% to 60%, and/or 60% to 75%. They may also have duty cycles that range from 20% to 25%, 25% to 30%, 30% to 35%, 35% to 40%, 40% to 45%, 45% to 50%, 50% to 55%, 55% to 60%, 60% to 65%, 65% to 70%, 70% to 75%, 75% to 80%, 80% to 85%, 85% to 90%, 90% to 95%, and/or 95% to 100%. The range may of course include more than the ranges provided herein and may include a greater range or a smaller range.

In one aspect of the technology, the on-off cycle (i.e., the rate at which the LEDs are turned on and off) is greater than about 80 KHz to about 100 KHz. In another aspect, the on-off cycle is greater than about 100 KHz to about 120 KHz. In another aspect of the technology, the on-off cycle ranges from about 10 KHz to about 200 KHz. In another aspect, the on-off cycle ranges from about 1 KHz to about 20 KHz. Advantageously, the device can be operating in a “dimmed” UV mode while either still providing LED white light or with the perception of little to no UV light at all. The device can also be operated in a “dimmed” white light LED mode with little or no UV light being perceived. That is, the duty cycle of the UV LED may be 100% while the duty cycle of the white light LED is less than about 100% or vice versa. In addition, both lights may be operated at about 100% of the duty cycle or both may be operated at less than about 100% of the duty cycle. Reference may be made herein to LED lights that are not pulse width modulated. Most LED lights will not be operated in a static mode, meaning they will not truly be without any pulse width modulation. For purposes of this application, an LED light is effectively static or effectively without pulse width modulation if it is modulated at a frequency less than about 2 KHz.

While different aspects of the technology are referenced herein, it is understood that one or more aspects may be combined as suits a particular purpose. In one aspect of the technology, a first light source or first LED located on the bottom of the device 10 is configured to propagate/emit a wavelength of light at about 360 nm, or ranging from about 340 nm to about 380 nm or about 350 nm to about 370 nm. A second light source or second LED is also located on the bottom of the device 10 and is configured to propagate a wavelength of light at about 390 nm, or ranging from about 370 nm to about 410 nm, or 380 nm to about 400 nm. In one aspect of the technology, the first LED is powered at a first static power level and the second LED is powered at a second static power level. In one aspect of the technology, the power level for the first LED (the LED that is less visible to the human eye) is greater than the power level for the second LED (the LED that is more visible to the human eye). Advantageously, the end user perceives the UV LED light (the one more visible to the human eye) and understands that a UV LED light is being used to attract insects. However, the UV LED that is more perceptible to the human eye is operated at a level that requires less power consumption than the second LED that more specifically targets insects to be attracted to the device. In other words, more light (i.e., electromagnetic radiation) is emitted from the light source that is more detectable and attractive to insects than light that is detectable to the human eye.

In another aspect of the technology, a first light source or first LED is configured to propagate a wavelength of light at about 360 nm, or ranging from about 340 nm to about 380 nm, and a second light source or second LED is configured to propagate a wavelength of light at about 390 nm, or ranging from about 370 nm to about 410 nm. In one aspect of the technology, the second light source or second LED (or LED assembly) is configured to propagate light at a static power level. The first light source is configured to operate at a predetermined differing or random differing static power levels or having a pulsing pattern. It is believed that the insect may better perceive a random static power levels or pulsing patterns as movement as opposed to a static UV LED. As the first light source in this aspect is less visible to the human eye, a random or pulsing light pattern would not be a distraction or irritant to the user.

In another aspect of the technology, the lighting devices comprise a first light source or first LED configured to propagate a wavelength of light at about 360 nm, or ranging from about 340 nm to about 380 nm, and a second light source or second LED is configured to propagate a wavelength of light at about 390 nm, or ranging from about 370 nm to about 410 nm. In one aspect of the technology, the second light source or second LED (or LED assembly) is configured to propagate light at a static power level. The first light source is configured to operate having a randomized duty cycle or a preset plurality of duty cycles. Meaning, the first light source operates at a first duty cycle (e.g., 25%) for a first period of time (e.g., 5 s, 10 s, or 15 s) and then operates at a second duty cycle (e.g., 50% or more) for a second period of time (e.g., 5 s, 10 s, or 15 s). In addition, the first and second LEDs may be operated at different duty cycles in order to increase a desired effect by the user. For example, the duty cycle for the first LED could be increased while the duty cycle of the second LED is decreased. In another aspect, the duty cycle of each is substantially the same, but the number of LEDs disposed about the device is different creating a different effect for the end user and/or changing the overall power consumption of the device. That is, a first light source (e.g., the source less visible to the human eye) comprises a plurality of LEDs that are greater than the plurality of LEDs of the second light source or vice versa. The duty cycles for each light source may be the same, but the relative power consumption is different because the total number of LEDs in the light source is different.

In another aspect of the technology, the lighting devices comprise LEDs wherein a frequency of light is propagated from the LEDs for a first period of time (e.g., 5 s, 10 s, or 15 s), a second frequency of light is propagated from the LEDs for a second period of time, and a third frequency of light is propagated from the LEDs for a third period of time. The first, second, and third periods of time may be the same, or they may be different as suits a particular purpose. In an additional aspect, the different frequencies are propagated from different LEDs and not necessarily from the same LED or the same group of LEDs. For example, in one aspect, light is propagated from the lighting device from one or more LEDs at 380 nm for 5 seconds, at 390 nm for 5 seconds, and then 400 nm for 5 seconds. The light may be propagated at a static power level or a variable duty cycle.

In another aspect of the technology, the first LED or first light source comprises one or more LEDs configured to propagate light at a wavelength at about 1000 nm, ranging from about 900 nm to about 1100 nm, corresponding to the normal wavelength at which humans irradiate heat. In one aspect of the technology, the second light source (operating at a UV wavelength and/or visible light wavelength, e.g.,) is maintained at a static power level or a low duty cycle (e.g., 25% to 35%) while the first light source is maintained at a high static power level, a medium or high duty cycle (e.g., 45% to 55% or 65% to 75%, respectively), a randomized static power level, and/or randomized duty cycle, or a preset variation of static power levels or duty cycles as suits a particular purpose. It is believed that certain insects are attracted to the heat signature of the human body.

It is understood that this aspect, as well as other aspects described herein, can be used in combination with other aspects. For example, in the aspect immediately describe above (i.e., the human heat signature aspect), a third light source can be incorporated that propagates light in the UV wavelength which may be less visible or not visible at all to the human eye. Moreover, in one aspect, there may be no light source that is visible to the human eye at all. Rather, the device propagates light only in wavelengths that are not visible to the normal human eye. In still another aspect, the device may include light sources that are not visible to the human eye and are intended to attract insects, but also includes an LED configured to propagate normal white light similar to commercially available flashlights or lanterns.

In addition to the aspects described herein with respect to termination of insects via an electronic grid or electrically charged surface, it is understood that the lighting technology can be used with other insect termination devices. For example, instead of (or in addition to) an electronic grid, insects may be attracted to an adhesive disposed about a portion of the device, including, but without limitation, a removable card with adhesive disposed thereon. In another aspect, the trap comprises a fan that makes physical contact with the insect and terminates the insect upon entering the trap. In another aspect, the trap comprises a one way entrance wherein the insect enters but cannot exit and eventually expires.

While methods of operation and extermination of insects with the current technology are described above, it is noted that the current technology comprises a method of exterminating an insect and/or operating an insect extermination device that includes propagating a first wavelength of light from a housing, the first wavelength of light ranging from about 370 nm to about 410 nm at a first duty cycle and propagating a second wavelength of light from the housing concurrently with the first wavelength of light, the second wavelength of light ranging from about 340 nm to about 380 nm at a second duty cycle, the second duty cycle being greater than the first duty cycle. In one aspect, the first duty cycle is less than 50% and the second duty cycle is greater than 50%. The first and second wavelengths of light may be propagated from one or more LEDs. The method also includes providing an electric current to an electrically conductive surface disposed about the housing, the conductive surface configured to exterminate an insect when the insect contacts the conductive surface. The electrically conductive surface is an example of a trap that is used in connection with the current technology, though other traps are contemplated for use in connection with the method including an adhesive, a chamber where insects are attracted to enter but have difficulty leaving, or a chamber where the insects are destroyed by a blade or other blunt surface.

In addition to the first and second wavelengths of light, in one aspect, the method also comprises propagating a third wavelength of light ranging from about 380 nm to about 720 nm (a visible or “white” wavelength) and/or ranging from about 900 nm to about 1100 nm or about 950 nm to about 1050 nm. In one aspect the third wavelength is propagated at a duty cycle less than the duty cycle of second wavelength of light.

In an additional aspect, the method comprises adjusting the duty cycle of the second wavelength and/or the 900 nm to 1100 nm wavelength of light at predetermined period of time. The method further comprises maintaining the duty cycle of the first wavelength and/or the visible wavelength of light at a substantially constant duty cycle in one aspect and at a random duty cycle in another aspect.

In one aspect of the technology, a method comprises switching a single LED disposed about an electrified grid configured to terminate insects between an on position and off position. It also comprises using numbers assigned from a random number generation process to adjust the power level sent to the single LED, the duty cycle of the single LED, or the frequency or amplitude of light propagated by the single LED within a predetermined set of time segments and/or a predetermined set of time increments while the single LED is in an on status.

It is noted that no specific order is required in these methods unless required by the claims set forth herein, though generally in some embodiments, the method steps can be carried out sequentially.

The foregoing detailed description describes the technology with reference to specific exemplary aspects. However, it will be appreciated that various modifications and changes can be made without departing from the scope of the present technology as set forth in the appended claims. The detailed description and accompanying drawing are to be regarded as merely illustrative, rather than as restrictive, and all such modifications or changes, if any, are intended to fall within the scope of the present technology as described and set forth herein.

More specifically, while illustrative exemplary aspects of the technology have been described herein, the present technology is not limited to these aspects, but includes any and all aspects having modifications, omissions, combinations (e.g., of aspects across various aspects), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, the term “preferably” is non-exclusive where it is intended to mean “preferably, but not limited to.” Any steps recited in any method or process claims may be executed in any order and are not limited to the order presented in the claims. Accordingly, the scope of the invention should be determined solely by the appended claims and their legal equivalents, rather than by the descriptions and examples given above.

1. An insect control device, comprising:
a housing;
a power source disposed about the housing;
a light source disposed about the housing comprising a single LED;
a controller coupled to the light source, the controller programmed to turn the single LED on at a randomized or pseudorandomized rate within a predetermined set of time segments and/or a predetermined set of time increments.

2. The insect control device of claim 1, wherein the controller is further programmed to adjust the power propagated to the single LED at a randomized rate within a predetermined set of time segments and/or a predetermined set of time increments.

3. The insect control device of claim 2, wherein the controller is further programmed to adjust the power propagated to the single LED within a predetermined power range.

4. The insect control device of claim 1, wherein the controller is further programmed to adjust the duty cycle of the single LED at a randomized rate within a predetermined set of time segments and/or a predetermined set of time increments.

5. The insect control device of claim 4, wherein the controller is further programmed to adjust the duty cycle propagated to the single LED within a predetermined duty cycle range.

6. The insect control device of claim 1, wherein the controller is further programmed to adjust the frequency or amplitude of light propagated by the single LED at a randomized rate within a predetermined set of time segments and at a predetermined set of time increments.

7. The insect control device of claim 6, wherein the controller is further programmed to adjust the frequency or amplitude of light propagated by the single LED within a predetermined range.

8. The insect control device of claim 1, wherein the predetermined set of time segments comprises 0.01 to 0.1 seconds, 0.1 to 0.5 seconds, or 0.5 to 1 seconds.

9. The insect control device of claim 1, wherein the predetermined set of time increments comprises 0.01 seconds, 0.25 seconds, 0.5 seconds, 0.75 seconds, or 0.1 seconds.

10. The insect control device of claim 1, wherein the controller comprises a programmable control circuit programed with a random number generating algorithm.

11. The insect control device of claim 6, wherein the programmable control circuit comprises a PRNG process.

12. A portable insect control device, comprising:
a housing having a top and a base;
a portable power source disposed about the housing;
a first light source disposed about the base of the housing;
a second light source comprising a single LED disposed about the housing;
a translucent shroud disposed about the second light source;
the controller programmed to randomly adjust the power level sent to the single LED, the duty cycle of the single LED, or the frequency of light propagated by the single LED while in an on status within a predetermined set of time segments and/or a predetermined set of time increments.

13. The insect control device of claim 12, further comprising an electric grid disposed about the second light source.

14. The insect control device of claim 12, further comprising an adhesive configured to trap insects thereon.

15. The insect control device of claim 12, wherein the controller is further programmed to turn the single LED on and off at a randomized rate within a predetermined set of time segments and/or a predetermined set of time increments.

16. A method of operating an insect control device, comprising:
switching a single LED disposed about an insect trap between an on position and off position;
using numbers assigned from a random number generation process to adjust the power level sent to the single LED, the duty cycle of the single LED, or the frequency of light propagated by the single LED within a predetermined set of time segments and/or a predetermined set of time increments while the single LED is in an on status.

17. The method of claim 16, further comprising using numbers assigned from a random number generated process to adjust the power propagated to the single LED within a predetermined power range.

18. The method of claim 16, further comprising using numbers assigned from a random number generated process to adjust the duty cycle propagated to the single LED within a predetermined duty cycle range.

19. The method of claim 16, further comprising using numbers assigned from a random number generated process to adjust the frequency of light propagated by the single LED within a predetermined frequency range.

20. The method of claim 16, further comprising using numbers assigned from a random number generated process to turn the single LED on and off at a randomized rate or pseudorandomized rate within a predetermined set of time segments and/or a predetermined set of time increments.

21. The method of claim 16, further comprising using the amount of power remaining in a battery coupled to the device to determine adjustments to the light source that are available for use with the insect control device.

22. A portable insect control device, comprising:
a housing having a top and a base;
a portable power source disposed about the housing;
a first light source disposed about the base of the housing;
a second light source comprising a single LED disposed about the housing;
a translucent shroud disposed about the second light source;
the controller programmed to adjust the power level sent to the single LED, the duty cycle of the single LED, or the frequency of light propagated by the single LED while in an on status according to a predetermined pattern, within a predetermined set of time segments and/or a predetermined set of time increments in such a way that the user cannot discern that the adjusted parameter is adjusted according to a predetermined pattern.

23. The portable insect control device of claim 22, further comprising a light pipe disposed about the single LED.
